(19) United States
(12) Patent Application Publication
(10) Pub. No.: US 2016/0055880 A1
(43) Pub. Date: Feb. 25, 2016

(54) SPINDLE MOTOR AND RECORDING DISK DRIVING DEVICE INCLUDING THE SAME

(71) Applicant: Samsung Electro-Mechanics Co., Ltd., Suwon-Si (KR)

(72) Inventors: Duck Shik KIM, Suwon-Si (KR); Sung Tai JUNG, Suwon-Si (KR)

(73) Assignee: SAMSUNG ELECTRO-MECHANICS CO., LTD., Suwon-Si (KR)

(21) Appl. No.: 14/637,030

(22) Filed: Mar. 3, 2015

(30) Foreign Application Priority Data
Aug. 22, 2014 (KR) 10-2014-0109850

(51) Int. Cl. G11B 19/20; H02K 7/08

(52) U.S. Cl. CPC G11B 19/2009; H02K 7/086

(57) ABSTRACT

A spindle motor includes a base member including an installation member formed of a magnetic material, a sleeve fixedly coupled to a mounting part provided in the base member, a shaft rotatably installed in a shaft hole of the sleeve, a rotor hub installed on an upper end portion of the shaft to rotate together with the shaft, a driving magnet fixedly coupled to a lower surface of the rotor hub, and a coil fixedly coupled to the installation member so as to be disposed to face the driving magnet.

### CROSS-REFERENCE TO RELATED APPLICATION

This application claims the priority and benefit of Korean Patent Application No. 10-2014-0109850 filed on Aug. 22, 2014, with the Korean Intellectual Property Office, the disclosure of which is incorporated herein by reference.

### BACKGROUND

The present disclosure relates to a spindle motor and a recording disk driving device including the same.

A hard disk drive (HDD), an information storage device, reads data stored on a disk or writes data to a disk using a read/write head.

Such a hard disk drive requires a disk driving device capable of driving a disk. In such a disk driving device, a small sized spindle motor is commonly used.

Meanwhile, a driving magnet and a stator core around which a coil is wound may be provided in the spindle motor in order to rotate the disk, wherein the driving magnet and the stator core are commonly disposed to face each other in a radial direction.

However, in the case of the miniaturization and thinning of spindle motors, a thickness of the spindle motor should be decreased, but in the case in which the driving magnet and the stator core are disposed to face each other in the radial direction, there may be limitations in decreasing the thickness of the spindle motor.

Further, in the case of installing the driving magnet and the coil to be disposed to face each other in an axial direction, (that is, in the case of installing the driving magnet and the coil in an axial direction manner, driving torque may be decreased, due to the omission of a core.

Therefore, the development of a structure allowing for motor thinness without decreasing driving torque is urgently required.

### RELATED ART DOCUMENT

### (Patent Document 1) Korean Patent Laid-Open Publication No. 2012-0140067

### SUMMARY

An aspect of the present disclosure may provide a spindle motor having an improved manufacturing yield and a recording disk driving device including the same.

An aspect of the present disclosure may also provide a spindle motor having increased driving torque and a recording disk driving device including the same.

According to an aspect of the present disclosure, a spindle motor may include, a base member including an installation member formed of a magnetic material, a sleeve fixedly coupled to a mounting part provided in the base member, a shaft rotatably installed in a shaft hole of the sleeve, a rotor hub installed on an upper end portion of the shaft to rotate together with the shaft, a driving magnet fixedly coupled to a lower surface of the rotor hub, and a coil fixedly coupled to the installation member to be disposed to face the driving magnet.

The installation member may be provided as a plurality of installation members disposed to be spaced apart from each other in a circumferential direction of the shaft, and the coil may include an installation hole formed therein into which the installation member is inserted.

The installation member may be configured of a protrusion molded integrally with the base member.

The installation member may have an elastic force providing hole formed therein so that the coil may be easily coupled to the installation member.

The installation member may have a depression groove formed therein so that the coil may be easily coupled to the installation member.

The base member may include an installation part in which the installation member may be provided.

The installation member may include a body inserted into an installation groove of the installation part and a pin portion protruding from the body to be disposed in an insertion hole of the installation part while penetrating therethrough.

The installation member may be formed of a magnetic material to generate driving force by electromagnetic interaction with the driving magnet.

The plurality of installation members may be disposed to be spaced apart from each other in the circumferential direction.

According to another aspect of the present disclosure, a recording disk driving device may include the spindle motor as described above, a head transfer part transferring a head reading information from a recording disk mounted on the spindle motor to the recording disk, and an upper case coupled to the base member provided in the spindle motor to form an internal space for accommodating the spindle motor and the head transfer part.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is a perspective view showing a base member of the spindle motor according to an exemplary embodiment of the present disclosure;

FIG. 3 is a schematic cross-sectional view showing a spindle motor according to another exemplary embodiment of the present disclosure;

FIG. 4 is a schematic cross-sectional view showing a spindle motor according to another exemplary embodiment of the present disclosure;

FIG. 5 is a schematic cross-sectional view showing a spindle motor according to another exemplary embodiment of the present disclosure;

FIG. 6 is a schematic cross-sectional view showing a spindle motor according to another exemplary embodiment of the present disclosure; and

FIG. 7 is a schematic cross-sectional view showing a recording disk driving device according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

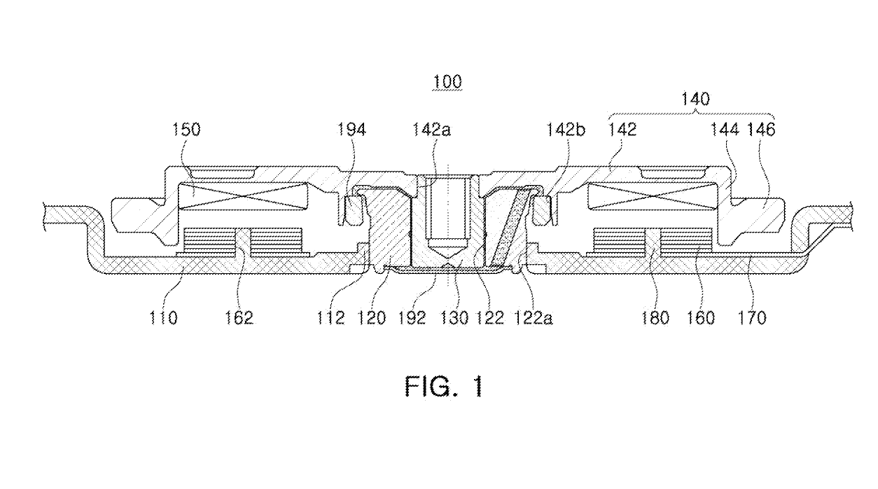

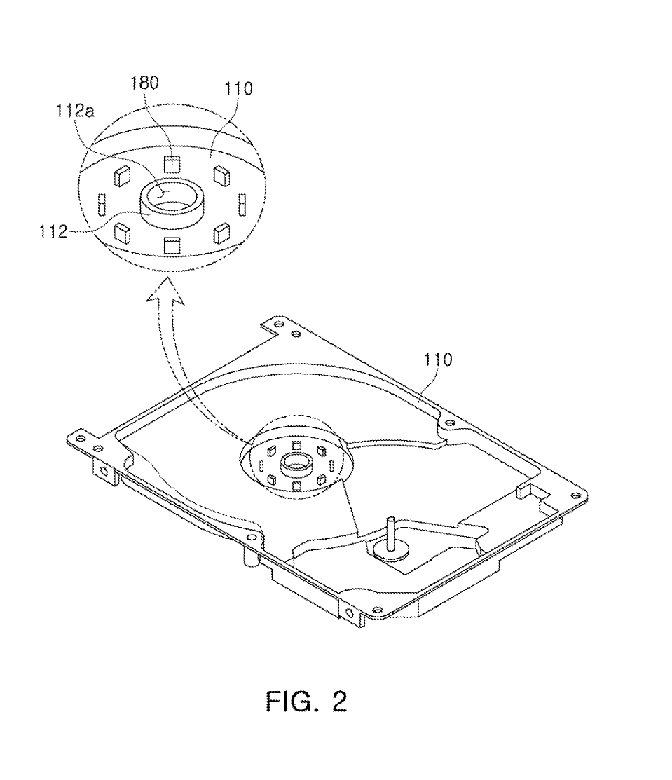

FIG. 1 is a schematic cross-sectional view showing a spindle motor according to an exemplary embodiment of the present disclosure, and FIG. 2 is a perspective view showing a base member of the spindle motor according to an exemplary embodiment of the present disclosure.

Referring to FIGS. 1 and 2, a spindle motor 100 according to an exemplary embodiment of the present disclosure may include, for example, a base member 110, a sleeve 120, a shaft 130, a rotor hub 140, a driving magnet 150, a coil 160, and a circuit board 170.

Meanwhile, the spindle motor 100 according to an exemplary embodiment of the present disclosure may be a motor used in a recording disk driving device to be described below.

The base member 110 may include an installation member 180 formed of a magnetic material. Meanwhile, the base member 110 may include a mounting part 112 having the sleeve 120 installed therein. Amounting groove 112a in which the sleeve 120 is insertedly installed may be formed in the mounting part 112, and the mounting part 112 may protrude upwardly in an axial direction.

Here, terms with respect to directions will be defined. As viewed in FIG. 1, the axial direction refers to a vertical direction, that is, a direction from a lower portion of the shaft 130 toward an upper portion thereof or a direction from the upper portion of the shaft 130 toward the lower portion thereof, and a radial direction refers to a horizontal direction, that is, a direction from an outer peripheral surface of the rotor hub 140 toward the shaft 130 or from the shaft 130 toward the outer peripheral surface of the rotor hub 140.

In addition, a circumferential direction refers to a rotation direction along an outer peripheral surface of the shaft 130.

Meanwhile, the installation member 180 provided in the base member 110 may be molded integrally with the base member 110, and the base member 110 may be formed of a magnetic material. As an example, the base member 110 may be molded by performing plastic working on a steel plate.

In addition, a plurality of installation members 180 may be disposed to be spaced apart from each other in the circumferential direction. Further, the installation member 180 may be molded integrally with the base member 110.

The detailed description thereof will be provided below.

The sleeve 120 may rotatably support the shaft 130. In addition, as described above, the sleeve 120 may be fixedly coupled to the mounting part 112 of the base member 110. That is, a lower end portion of an outer peripheral surface of the sleeve 120 may be bonded to an inner peripheral surface of the mounting part 112 by an adhesive.

However, the present disclosure is not limited thereto, but the sleeve 120 may also be press-fitted into the mounting part 112 or be bonded to the mounting part 112 by welding.

Further, the sleeve 120 may include a shaft hole 122 formed therein so that the shaft 130 may be insertedly disposed therein. That is, the sleeve 120 may have a hollow cylindrical shape.

Meanwhile, in the case in which the shaft 130 is insertedly disposed in the sleeve 120, an inner peripheral surface of the sleeve 120 and an outer peripheral surface of the shaft 130 may be spaced apart from each other by a predetermined interval to thereby form a bearing clearance therebetween. This bearing clearance may be filled with a lubricating fluid.

In addition, a cover member 192 may be installed on a lower portion of the sleeve 120 in order to prevent the lubricating fluid filled in the bearing clearance from being leaked downwardly.

Here, the bearing clearance will be briefly described. The bearing clearance means clearances formed by the sleeve 120 and the shaft, the sleeve 120, and the rotor hub 140, the cover member 192 and the sleeve 120, and the cover member 192 and the shaft 130, and the lubricating fluid may be filled in the bearing clearance.

That is, the spindle motor 100 according to an exemplary embodiment of the present disclosure may have a full-fill structure in which the lubricating fluid is filled in all of the above-mentioned bearing clearances.

Meanwhile, upper and lower radial dynamic pressure grooves (not shown) may be formed in at least one of the inner peripheral surface of the sleeve 120 or the outer peripheral surface of the shaft 130. The upper and lower radial dynamic pressure grooves may be disposed to be spaced apart from each other in the axial direction by a predetermined interval, and generate fluid dynamic pressure in the radial direction at the time of rotation of the shaft 130. Therefore, the shaft 130 may more stably rotate.

The shaft 130 may be rotatably installed in the sleeve 120. That is, the shaft 130 may be insertedly disposed in the shaft hole 122 of the sleeve 120. Further, the rotor hub 140 may be fixedly installed on the upper end portion of the shaft 130. To this end, the upper end portion of the shaft 130 may protrude upwardly of the sleeve 120.

Meanwhile, the rotor hub 140 may be fixedly coupled to the upper end portion of the shaft 130 as described above, such that the shaft 130 and the rotor hub 140 may rotate together with each other.

The rotor hub 140 may be installed on the upper end portion of the shaft 130 to thereby rotate together with the shaft 130. Meanwhile, the rotor hub 140 may include a rotor hub body 142 including a through hole 142a formed therein so that the upper end portion of the shaft 130 is inserted thereinto and having a disk shape, an extension part 144 extended downwardly from an edge of the rotor hub body 142 in the axial direction, and a disk support part 146 extended from a distal end of the extension part 144 in an outer diameter direction.

In addition, the driving magnet 150 may be installed on a lower surface of the rotor hub 140, that is, a lower surface of the rotor hub body 142.

In addition, an extension wall part 142b having a stopper member 194 installed thereon may be formed in the rotor hub body 142 to be disposed in an inner diameter direction of the driving magnet 150.

The stopper member 194 may serve to prevent the shaft 130 from being separated from the sleeve 120 at the time of external impact while preventing the shaft 130 from being excessively floated at the time of rotation of the rotor hub 140.

The driving magnet 150 may be fixedly coupled to the lower surface of the rotor hub 140, that is, the lower surface of the rotor hub body 142. The driving magnet 150 may be a permanent magnet of which an N pole and an S pole are alternately magnetized in the circumferential direction. In addition, the driving magnet 150 may have a ring shape.

The coil 160 may be fixedly coupled to the installation member 180 to be disposed to face the driving magnet 150. In addition, a plurality of coils 160 may be provided to be coupled to the installation members 180 disposed to be spaced apart from each other in the circumferential direction, respectively.

In other words, the number of installation member 180 may correspond to the number of coils 160.

Meanwhile, an installation hole 162 may be formed in the coil 160 into which the installation member 160 is inserted.

The circuit board 170 may be disposed between the coil 160 and the base member 110 and serve to insulate the coil 160 and the base member 110 from each other. To this end, the circuit board 170 may be formed of an insulating material, and a wiring pattern (not shown) for electric connection with the coil 160 may be formed on the circuit board 170.

As described above, the driving magnet 150 and the coil 160 are installed to be disposed to face each other in the axial direction, such that thinness of the spindle motor 100 may be implemented.

Further, the coil 160 is coupled to the installation member 180 of the base member 110, such that the coil may be easily assembled.

Further, the installation member 180 formed of the magnetic material may be formed integrally with the base member 110, such that a manufacturing cost may be decreased.

In addition, since the installation member 180 may serve as a core, a driving torque may be improved as compared to a spindle motor in which a core is omitted. In other words, in the case in which the driving magnet 150 and the coil 160 are installed to be disposed to face each other in an axial direction, according to the related art, a core is omitted, such that a driving torque may be decreased, but according to the present disclosure, the driving torque may be improved through the installation member 180.

Hereinafter, spindle motors according to other embodiments of the present disclosure will be described with reference to the accompanying drawings.

However, the same components as the above-mentioned components will be denoted by the same reference numerals and a detailed description thereof will be omitted.

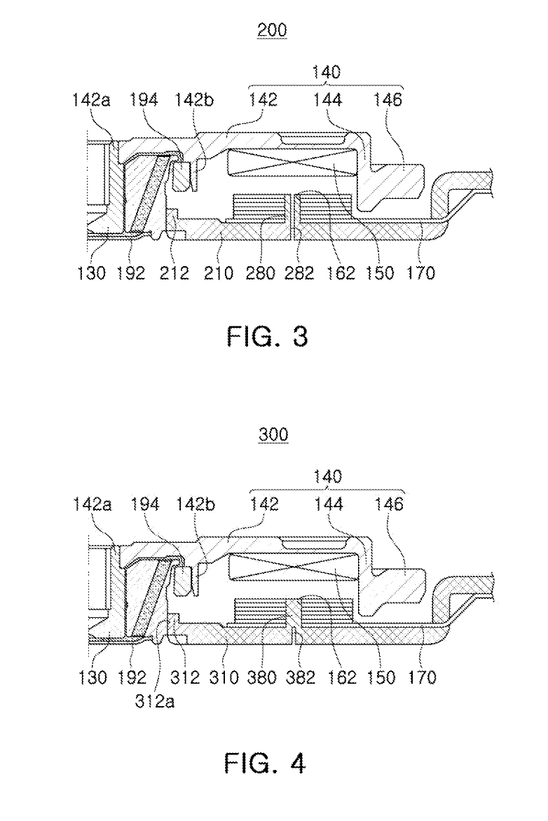

FIG. 3 is a schematic cross-sectional view showing a spindle motor according to another exemplary embodiment of the present disclosure.

Referring to FIG. 3, a base member 210 of a spindle motor 200 according to another exemplary embodiment of the present disclosure may include an installation member 280. Further, the installation member 280 may be formed integrally with a base member 210 and formed of a magnetic material.

Meanwhile, an elastic force providing hole 282 may be formed in the installation member 280 so that the installation member may be easily elastically deformed at the time of assembling a coil 160. In other words, in the case in which the installation member 280 is inserted into an installation hole 162 of a coil 160, the installation member 280 may be elastically deformed by the elastic force providing hole 282 and then pressurize an inner peripheral surface of the coil 160 by recovering force.

Therefore, coupling force between the coil 160 and the installation member 280 may be increased.

Meanwhile, a mounting part 212 having a sleeve 120 installed therein may be formed in the base member 210, and a mounting hole 212a may be formed in the mounting part 212 so that a lower end portion of the sleeve 120 may be insertedly disposed therein.

As described above, a driving magnet 150 and the coil 160 are installed to be disposed to face each other in an axial direction, such that thinness of the spindle motor 200 may be implemented.

Further, the coil 160 is coupled to the installation member 280 of the base member 210, such that the coil may be easily assembled.

Further, the installation member 280 formed of the magnetic material may be formed integrally with the base member 110, such that a manufacturing cost may be decreased.

In addition, since the installation member 280 may serve as a core, a driving torque may be improved as compared to a spindle motor in which the core is omitted. In other words, in the case in which the driving magnet 150 and the coil 160 are installed to be disposed to face each other in an axial direction, according to the related art, a core is omitted, such that a driving torque may be decreased, but according to the present disclosure, the driving torque may be improved through the installation member 180.

FIG. 4 is a schematic cross-sectional view showing a spindle motor according to another exemplary embodiment of the present disclosure.

Referring to FIG. 4, a base member 310 of a spindle motor 300 according to another exemplary embodiment of the present disclosure may include an installation member 380. Further, the installation member 380 may be formed integrally with the base member 310 and formed of a magnetic material.

Meanwhile, a depression groove 382 may be formed in the installation member 380 so that the installation member 380 may be easily coupled to a coil 160. Even in the case in which the center of the installation member 380 and the center of a driving magnet 150 are deviated from each other by a manufacturing tolerance, the depression groove 382 may serve to allow the center of the installation member 380 and the center of the driving magnet 150 to coincide with each other at the time of coupling the coil 160.

That is, the depression groove 382 may serve to guide the coil 160 to be coupled to a predetermined position.

Meanwhile, a mounting part 312 having a sleeve 120 installed therein may be formed in the base member 310, and a mounting hole 312a may be formed in the mounting part 312 so that a lower end portion of the sleeve 120 may be insertedly disposed therein.

As described above, the driving magnet 150 and the coil 160 are installed to be disposed to face each other in an axial direction, such that thinness of the spindle motor 300 may be implemented.

Further, the coil 160 is coupled to the installation member 380 of the base member 310, such that the coil may be easily assembled.

Further, the installation member 380 formed of the magnetic material may be formed integrally with the base member 110, such that a manufacturing cost may be decreased.

In addition, since the installation member 380 may serve as a core, a driving torque may be improved as compared to a spindle motor in which the core is omitted. In other words, in the case in which the driving magnet 150 and the coil 160 are installed to be disposed to face each other in an axial direction, according to the related art, a core is omitted, such that a driving torque may be decreased, but according to the present disclosure, the driving torque may be improved through the installation member 380.

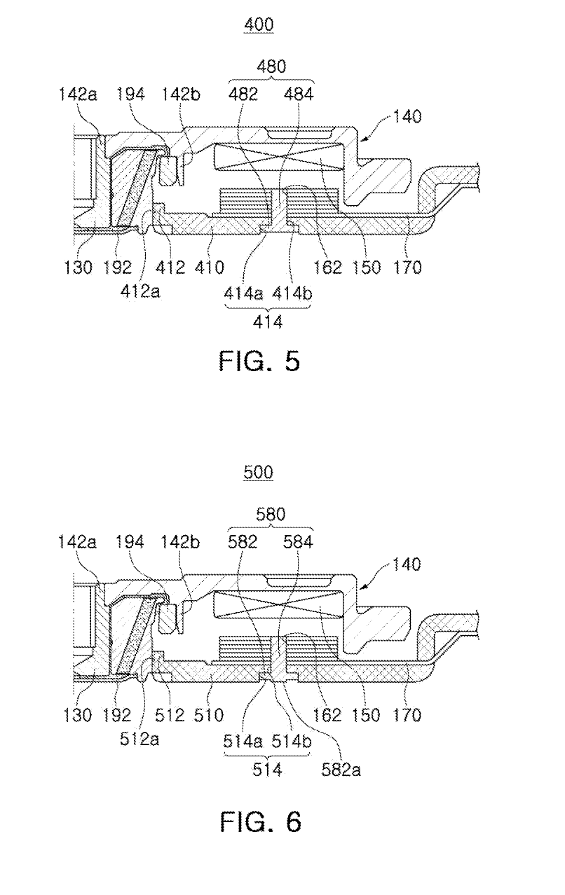

FIG. 5 is a schematic cross-sectional view showing a spindle motor according to another exemplary embodiment of the present disclosure.

Referring to FIG. 5, a base member 410 of a spindle motor 400 according to another exemplary embodiment of the present disclosure may include an installation member 480. In addition, the base member 410 may include an installation part 414 in which the installation member 480 is installed.

The installation part 414 may include an installation groove 414a into which a pin portion 484 of the installation member 480 is inserted and an installation hole 414b in which a pin portion 484 of the installation member 480 is disposed while penetrating therethrough.

In addition, the installation member 480 may include the body 482 insertedly disposed in the installation groove 414a and the pin portion 484 protruding from the body 482 and penetrating through the installation hole 414b to thereby protrude upwardly of the base member 410 as described above.

Meanwhile, the installation member 480 may be formed of a magnetic material so that the installation member 480 may serve as a core. In this case, the base member may not be formed of a magnetic material.

Further, a mounting part 412 having a sleeve 120 installed therein may be formed in the base member 410, and a mounting hole 412a may be formed in the mounting part 412 so that a lower end portion of the sleeve 120 may be insertedly disposed therein.

As described above, a driving magnet 150 and a coil 160 are installed to be disposed to face each other in an axial direction, such that thinness of the spindle motor 400 may be implemented.

Further, the coil 160 is coupled to the installation member 480 of the base member 410, such that the coil may be easily assembled.

In addition, since the installation member 480 may serve as the core, a driving torque may be improved as compared to a spindle motor in which the core is omitted. In other words, in the case in which the driving magnet 150 and the coil 160 are installed to be disposed to face each other in an axial direction, according to the related art, a core is omitted, such that a driving torque may be decreased, but according to the present disclosure, the driving torque may be improved through the installation member 480.

FIG. 6 is a schematic cross-sectional view showing a spindle motor according to another exemplary embodiment of the present disclosure.

Referring to FIG. 6, a base member 510 of a spindle motor 500 according to another exemplary embodiment of the present disclosure may include an installation member 580. In addition, the base member 510 may include an installation part 514 having the installation member 580 installed therein.

The installation part 514 may include an installation groove 514a into which a body 582 of the installation member 580 is inserted and an installation hole 514b in which a pin portion 584 of the installation member 580 is disposed while penetrating therethrough.

In addition, the installation member 580 may include the body 582 insertedly disposed in the installation groove 514a and the pin portion 584 protruding from the body 582 and penetrating through the installation hole 514b to thereby protrude upwardly of the base member 510 as described above.

Meanwhile, the installation member 580 may be formed of a magnetic material so that the installation member 480 may serve as a core. In this case, the base member may not be formed of a magnetic material.

In addition, a step part 582a protruding downwardly in an axial direction may be formed at a lower surface of the body 582 of the installation member 580. The body 582 may be easily inserted into the installation groove 514a and deterioration of rigidity of the pin portion 584 may be decreased by decreasing a thickness of the body 582 as described above.

As described above, a shape of the installation member is not limited to a shape of the installation member 480 provided in the spindle motor 400 according to another exemplary embodiment of the present disclosure but may be variously changed.

Further, a mounting part 512 having a sleeve 120 installed therein may be formed in the base member 510, and a mounting hole 512a may be formed in the mounting part 512 so that a lower end portion of the sleeve 120 may be insertedly disposed therein.

As described above, a driving magnet 150 and a coil 160 are installed to be disposed to face each other in an axial direction, such that thinness of the spindle motor 500 may be implemented.

Further, the coil 160 is coupled to the installation member 580 of the base member 510, such that the coil may be easily assembled.

In addition, since the installation member 580 may serve as the core, a driving torque may be improved as compared to a spindle motor in which the core is omitted. In other words, in the case in which the driving magnet 150 and the coil 160 are installed to be disposed to face each other in an axial direction, according to the related art, a core is omitted, such that a driving torque may be decreased, but according to the present disclosure, the driving torque may be improved through the installation member 580.

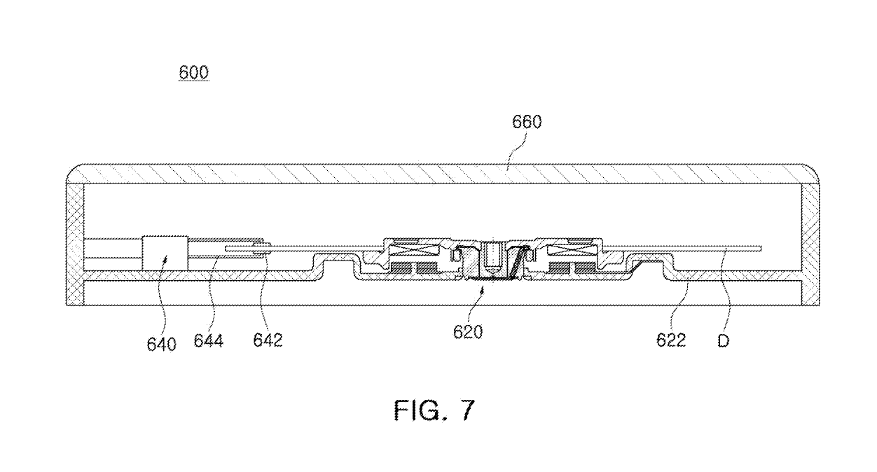

FIG. 7 is a schematic cross-sectional view showing a recording disk driving device according to an exemplary embodiment of the present disclosure.

Referring to FIG. 7, the recording disk driving device 600 according to an exemplary embodiment of the present disclosure may include, for example, a spindle motor 620, ahead transfer part 640, and an upper case 660.

The spindle motor 620 may be any one of the above-mentioned spindle motors according to exemplary embodiments of the present disclosure, and a recording disk D is mounted on the spindle motor 620.

The head transfer part 640 may transfer a head 642 reading information from the recording disk D mounted on the spindle motor 620 to a surface of the recording disk D of which the information is to be detected. The head 642 may be disposed on a support part 644 of the head transfer part 640.

The upper case 660 may be coupled to a base member 622 in order to form an internal space for accommodating the spindle motor 620 and the head transfer part 640.

As set forth above, according to an exemplary embodiment of the present disclosure, the manufacturing yield may be improved through the installation member provided in the base member.

Further, the decrease in the driving torque may be prevented through the installation member.

While exemplary embodiments have been shown and described above, it will be apparent to those skilled in the art that modifications and variations could be made without departing from the scope of the present invention as defined by the appended claims.

What is claimed is:

1. A spindle motor comprising:
a base member including an installation member formed of a magnetic material;
a sleeve fixedly coupled to a mounting part provided in the base member;
a shaft rotatably installed in a shaft hole of the sleeve;
a rotor hub installed on an upper end portion of the shaft to rotate together with the shaft;
a driving magnet fixedly coupled to a lower surface of the rotor hub; and
a coil fixedly coupled to the installation member to be disposed to face the driving magnet.

2. The spindle motor of claim 1, wherein the installation member is provided as a plurality of installation members disposed to be spaced apart from each other in a circumferential direction of the shaft, and
the coil includes an installation hole formed therein into which the installation member is inserted.

3. The spindle motor of claim 2, wherein the installation member is configured of a protrusion molded integrally with the base member.

4. The spindle motor of claim 3, wherein the installation member has an elastic force providing hole formed therein so that the coil may be easily coupled to the installation member.

5. The spindle motor of claim 3, wherein the installation member has a depression groove formed therein so that the coil is easily coupled to the installation member.

6. The spindle motor of claim 2, wherein the base member includes an installation part in which the installation member is provided.

7. The spindle motor of claim 6, wherein the installation member includes a body inserted into an installation groove of the installation part and a pin portion protruding from the body to be disposed in an insertion hole of the installation part while penetrating therethrough.

8. The spindle motor of claim 7, wherein the installation member is formed of a magnetic material to generate driving force by electromagnetic interaction with the driving magnet.

9. The spindle motor of claim 6, wherein the plurality of installation members are disposed to be spaced apart from each other in the circumferential direction.

10. A recording disk driving device comprising:
the spindle motor of claim 1, rotating a recording disk;
a head transfer part transferring a head reading information from the recording disk mounted on the spindle motor to the recording disk; and
an upper case coupled to the base member provided in the spindle motor to form an internal space for accommodating the spindle motor and the head transfer part.
